(19) United States
(12) Patent Application Publication
(10) Pub. No.: US 2023/0316864 A1
(43) Pub. Date: Oct. 5, 2023

(54) GAMING SYSTEM ALLOWING ACCUMULATION OF MULTIPLIERS FOR HIGH REWARD SCORE

(71) Applicant: Tien Shu HSU, Taichung (TW)

(72) Inventors: Shun Tsung HSU, Taichung (TW); Chang Yi WANG, Taichung (TW); Chih Kang PIEN, Taichung (TW)

(21) Appl. No.: 18/015,156

(22) PCT Filed: Jul. 14, 2020
(86) PCT No.: PCT/CN2020/101951

§ 371 Date: Jan. 9, 2023

(51) Int. Cl. G07F 17/32

(52) U.S. Cl. CPC G07F 17/3267; G07F 17/3213

(57) ABSTRACT

A gaming system allowing accumulation of multipliers for a high reward score. In a reel spinning game, if multiple symbols of a first group satisfy a trigger event, a reward game is started. The reward game has a basic score, an accumulating multiplier having an initial numerical value, and one or more free rounds conducted sequentially. In each of the free rounds, a game result generation unit generates multiple symbols of a second group and displays the symbols at multiple display locations of a game screen. If any one of the symbols of the second group is determined as a special pattern, a control unit causes the display location displaying the special pattern to maintain display of the special pattern during the reward game. If the special pattern has a percentage number symbol, the numerical value of the percentage number symbol is added to increase the numerical value of the accumulating multiplier. A multiplication product of the basic score and the most recent accumulating multiplier is used as a reward score of the special pattern.

### FIELD OF THE INVENTION

The invention relates to a game system, and more particularly to a game system for getting high reward score by accumulating multiples.

### BACKGROUND OF THE INVENTION

Please refer to FIG. 1 for a slot machine 1 with a plurality of rollers 2, after a player placed a bet, the slot machine 1 starts spinning of the rollers 2, and the player can obtain scores according to a symbol arrangement formed after the rollers 2 have stopped spinning. When a specific symbol appears or meets a preset condition, the slot machine 1 enters a certain quantity of rounds of reward games. The feature of reward game is free spin. The reward games allow the player to have a probability to get extra reward scores without cost. Therefore, free spin is one of the important features that attracts players to use the slot machine 1. Common game modes for reward games are selected from respin, bonus game, free game, retrigger, jackpot, and so on. Among them, the respin is as shown in a procedure in FIG. 4 of the U.S. Pat. No. 8,197,328; the bonus game is as shown in FIG. 1A, FIG. 1B, FIG. 3, FIG. 4A, FIG. 4B, FIG. 4C, FIG. 4D, FIG. 4E, FIG. 4F, FIG. 5, and FIG. 6, and lines 34˜50 of column 6 of the specification of the U.S. Pat. No. 6,602,137; the free game and the retrigger can be found in FIG. 3A, FIG. 3B, and FIG. 4 and lines 2-57 of column 6 of the specification of the U.S. Pat. No. 6,955,600; and for jackpot, please refer to the U.S. Pat. No. 10,176,670.

However, under a completely random setting, even in a reward game with a high probability of winning, the player has a considerable probability of not winning at all during the reward game, or winning but not accumulating many scores. In this situation, the player will suddenly fall into the emotion of no winning or winning a mini reward from the emotion of expecting a large reward, which can easily cause the player to have negative emotion, thus reducing the player's interest in using the slot machine 1.

More clearly, the score fluctuations of the conventional reward game are not too large, for players who are familiar with the game, the player can easily infer the approximate result of the conventional reward game. Therefore, the conventional reward game cannot achieve the effect of stimulating the player at all. The conventional reward game will instead become a breakpoint for the player to stop playing. After the reward game has ended, the player may directly end the game, which will affect the utilization rate of the slot machine 1 instead, thereby reducing the turnover of the slot machine 1.

### SUMMARY OF THE INVENTION

A main object of the invention is to disclose a game system with a reward game. In the reward game, a player increases score fluctuations of the reward game by accumulating multiples, so that the player can keep the hope of obtaining high reward scores in order to maintain the interest of the player for a long period of time and increase the time of use of the game system.

In order to achieve the above object, the invention discloses a game system for getting high reward score by accumulating multiples. The game system provides a slot game, the slot game includes a plurality of game results. The game system includes a display unit, a game result generating unit and a control unit. The display unit includes a game screen, the game screen displays real-time game images of the slot game, and the game screen includes a plurality of display positions arranged side by side. The game result generating unit generates a plurality of first group symbols, the first group symbols are displayed at the display positions of the game screen, and the slot game generates the different game results according to type composition of the first group symbols. The control unit is connected to the display unit and the game result generating unit, and the control unit performs the following steps: determining whether the game result latest generated meets an activation event, when meeting the activation event, starting a reward game, the reward game including a basic score and an accumulating reward multiple with an initial value, and the reward game including at least one free round performed sequentially; and performing the at least one free round sequentially.

In performing each round of the at least one free rounds of the reward game performed sequentially, the control unit further performs the following steps: generating a plurality of second group symbols through the game result generating unit, displaying the second group symbols at the display positions of the game screen; when determining that any one of the second group symbols generated by the game result generating unit being a special pattern, keeping display of the special pattern at the display position where the special pattern appearing in the reward game; when the special pattern including a percentage value symbol, accumulatively calculating a value of the percentage value symbol and a current value of the accumulating reward multiple to generate a latest value of the accumulating reward multiple; calculating a product of the basic score and the accumulating reward multiple latest generated to be used as a reward score of the special pattern; and determining whether the at least one free round of the reward game including been played, if so, ending the reward game, if otherwise, continuing the at least one free round sequentially.

Accordingly, in the process of performing the at least one free round sequentially by the invention, when the special pattern obtained includes the percentage value symbol, the value of the percentage value symbol can be accumulatively calculated to increase the value of the accumulating reward multiple, and therefore as long as the value of the accumulating reward multiple is continuously accumulated, the reward score of the special pattern will continue to rise. In other words, under a same operation mode, the system operator does not need to invest too much design cost, and through the same operation mode, the player has the opportunity to obtain a high amount of the reward score, which can increase a score fluctuation of the reward game. The player will not feel bored, can still maintain anticipation and surprise, and avoid the reward game from becoming a breakpoint for the player to stop playing.

### BRIEF DESCRIPTION OF THE DRAWINGS

FIG. 1 is a schematic diagram of an appearance of a conventional slot machine;

FIG. 2 is a block diagram of a system of the invention;

FIG. 3 is a schematic diagram of an appearance of a game machine of the invention;

FIG. 4 is a flow chart of game operation of a slot game of the invention;

FIG. 5 is a flow chart of game operation of a reward game of the invention; and

FIGS. 6A-6L are schematic diagrams of a game screen according to one embodiment of the invention.

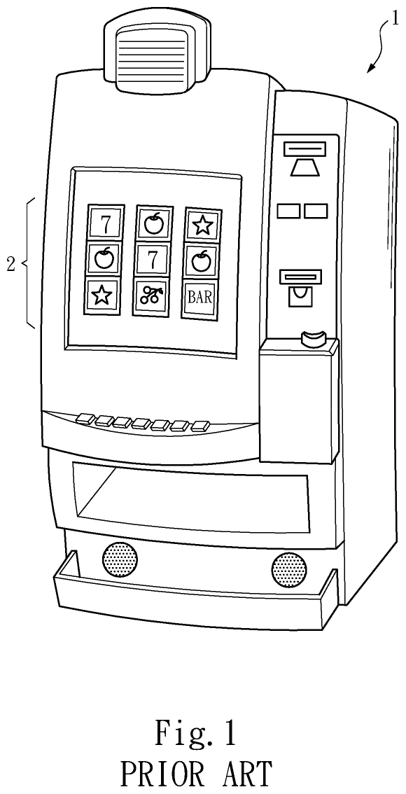

### DETAILED DESCRIPTION OF THE PREFERRED

### Embodiments

The detailed description and technical contents of the present invention are described below with reference to the drawings.

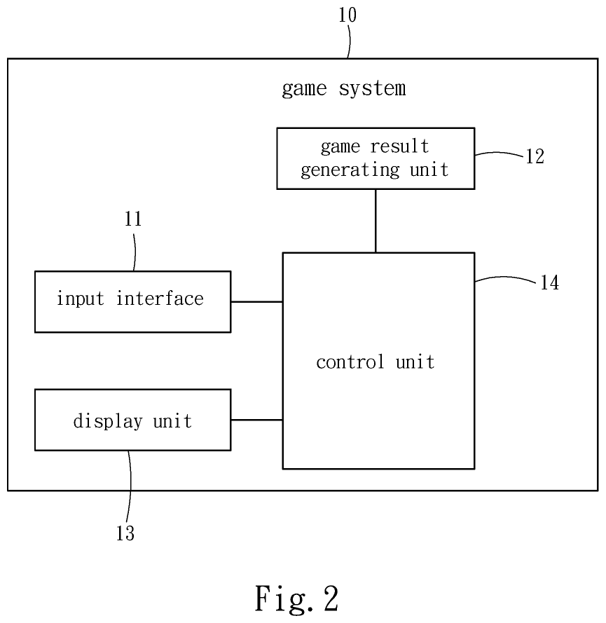

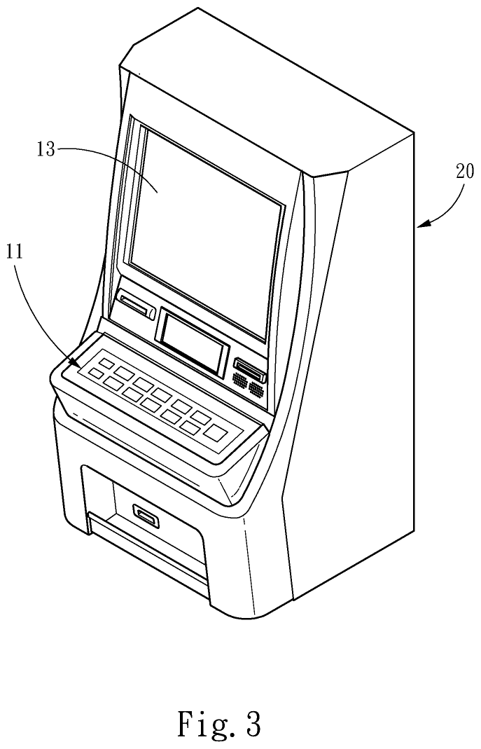

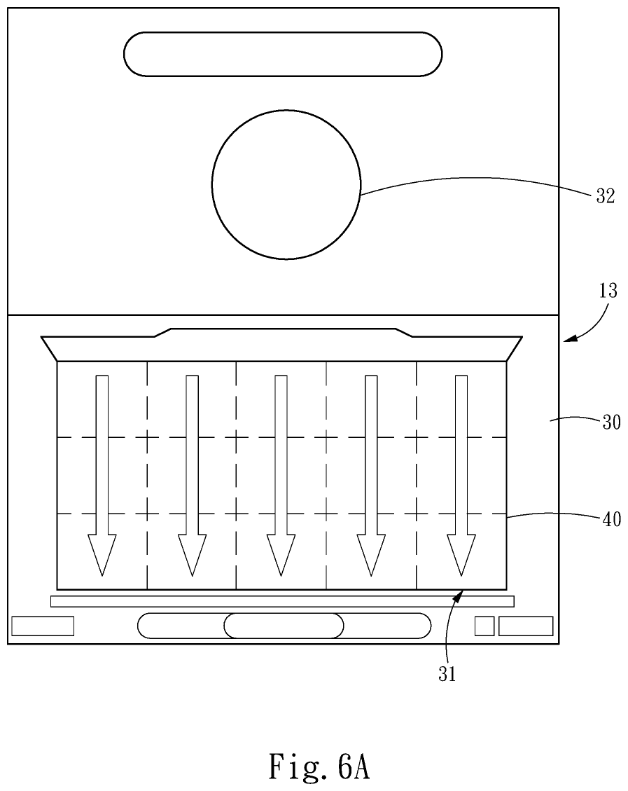

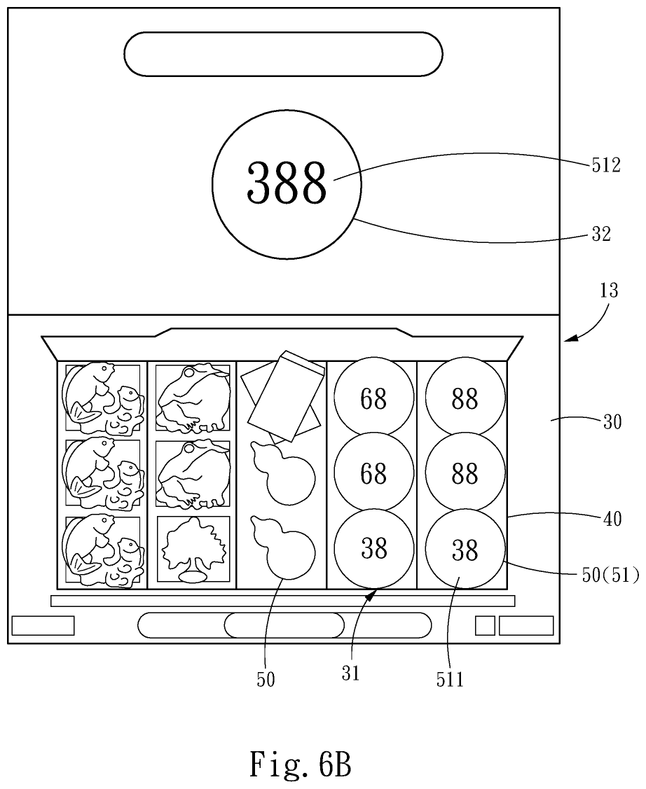

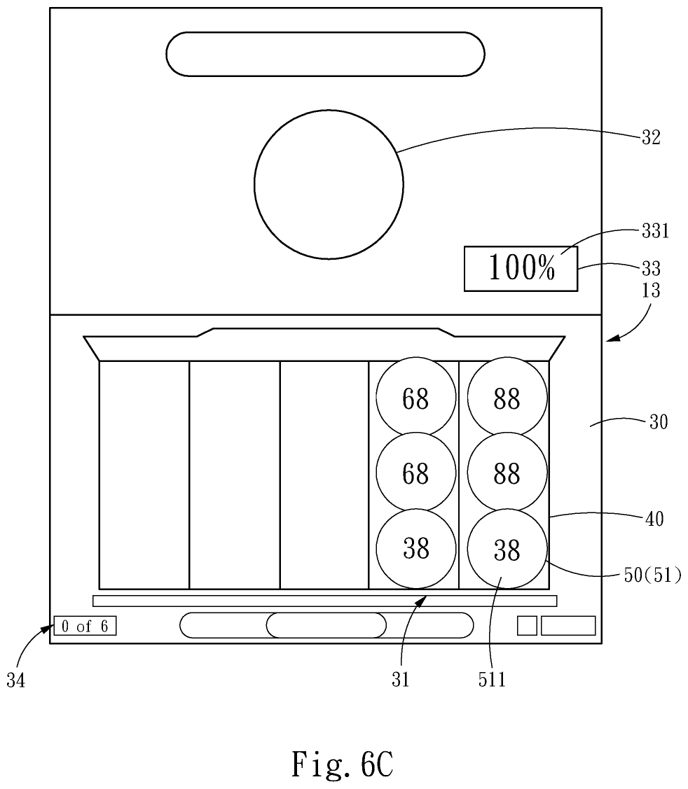

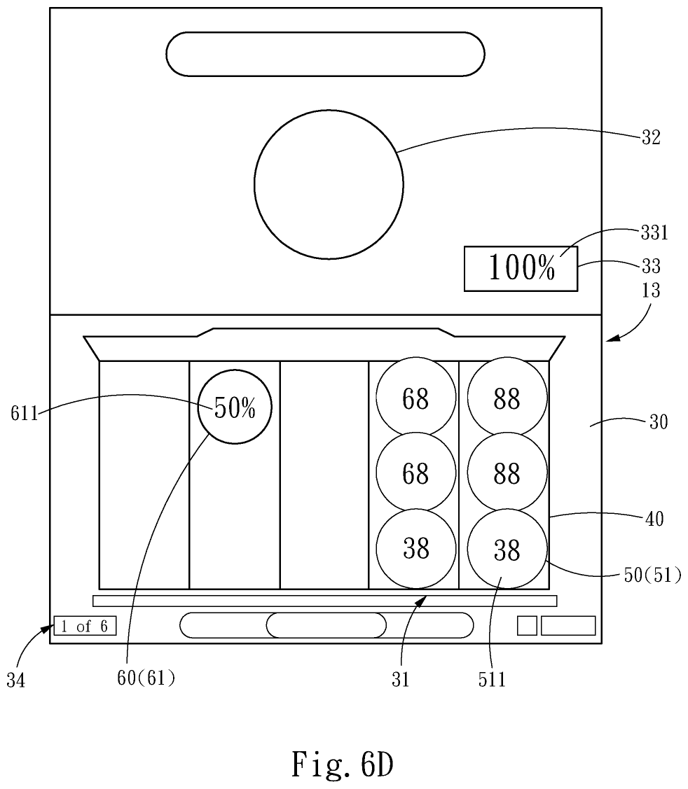

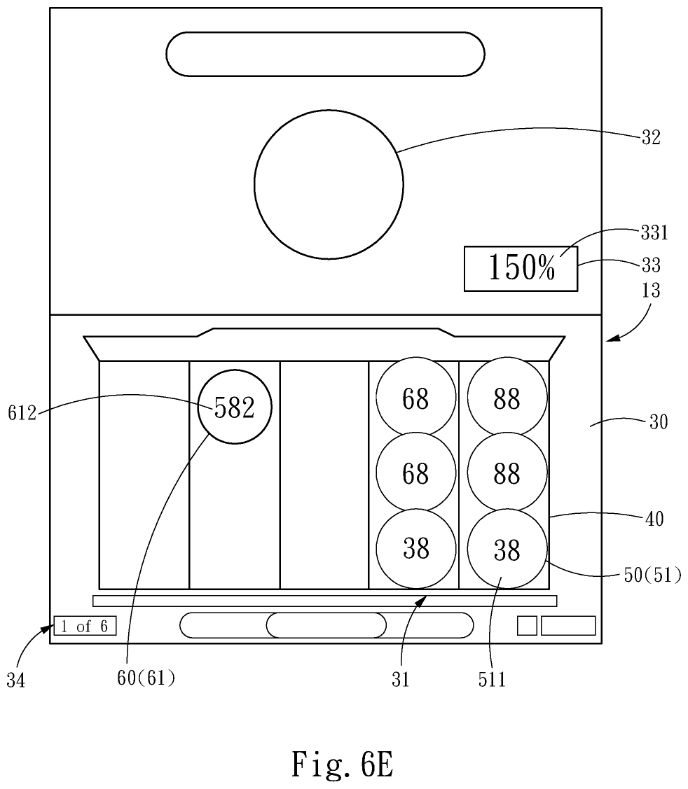

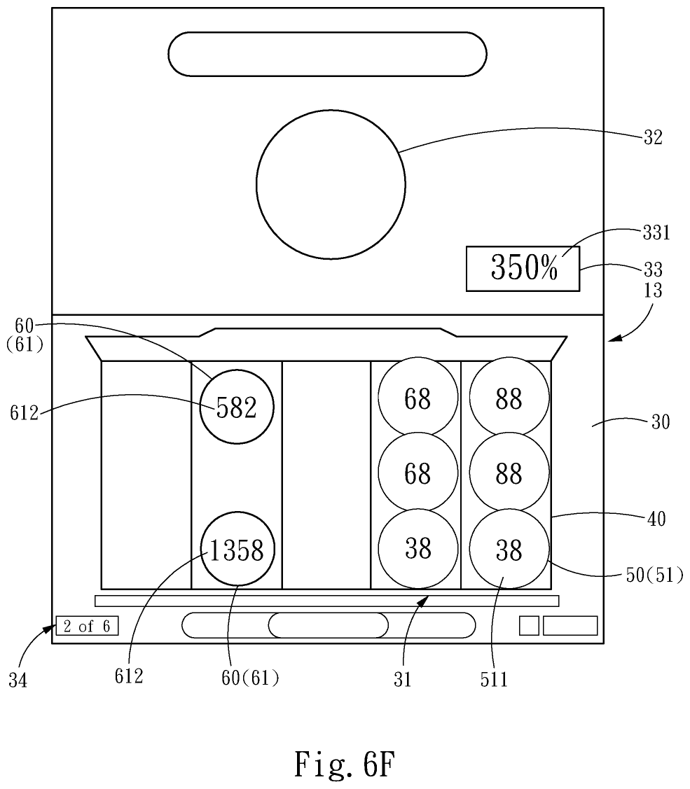

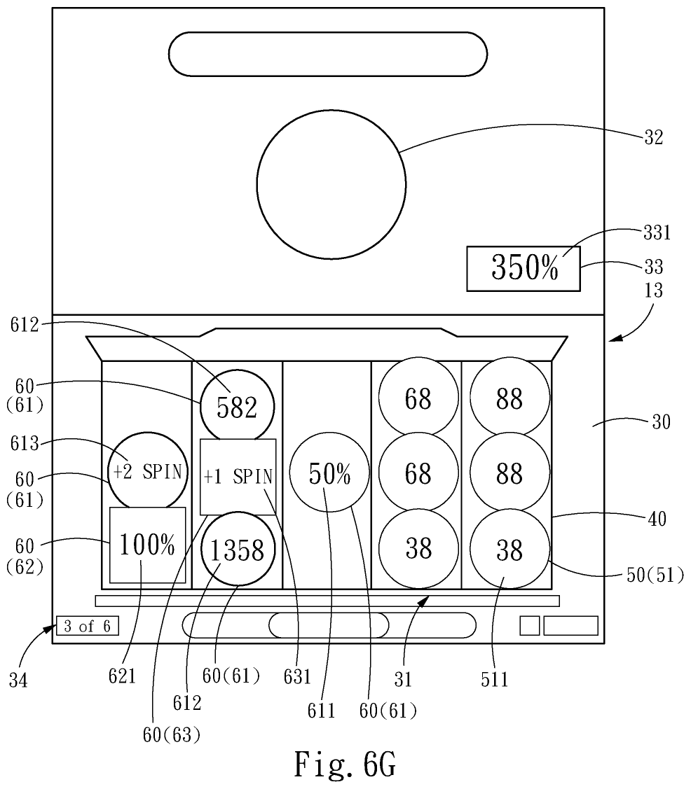

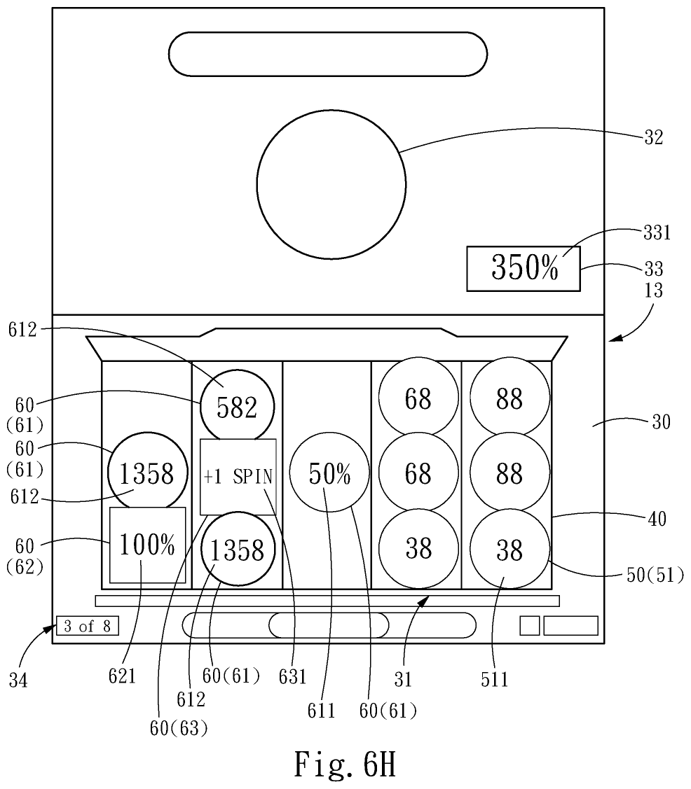

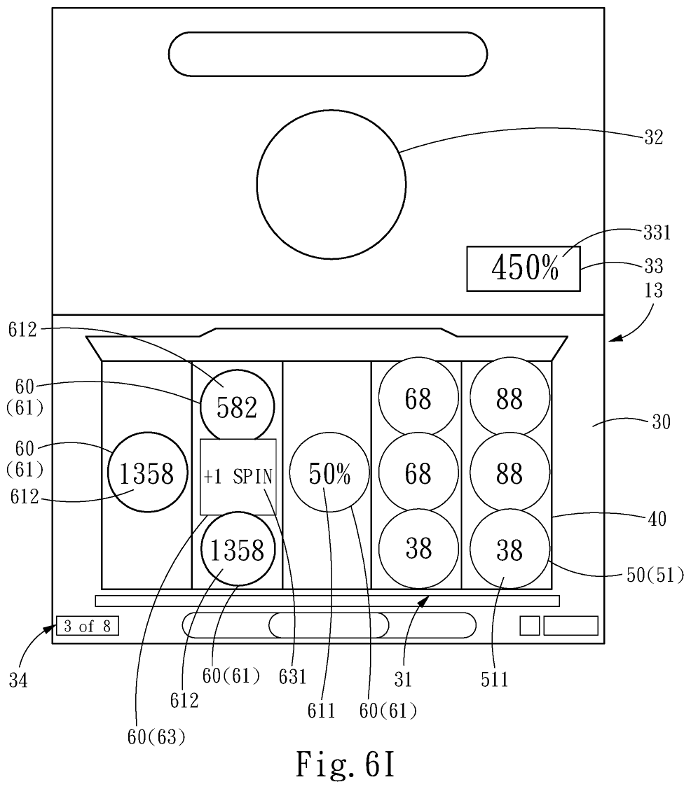

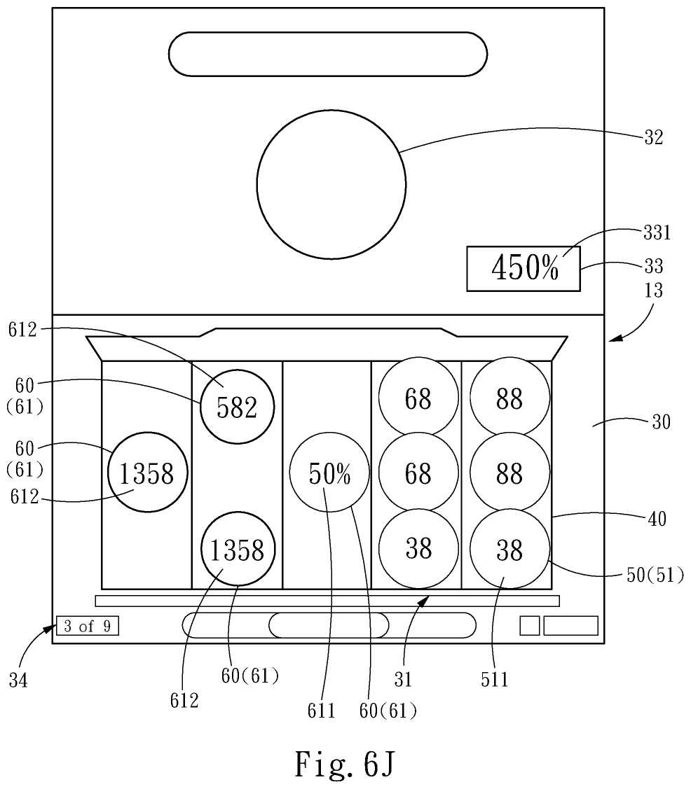

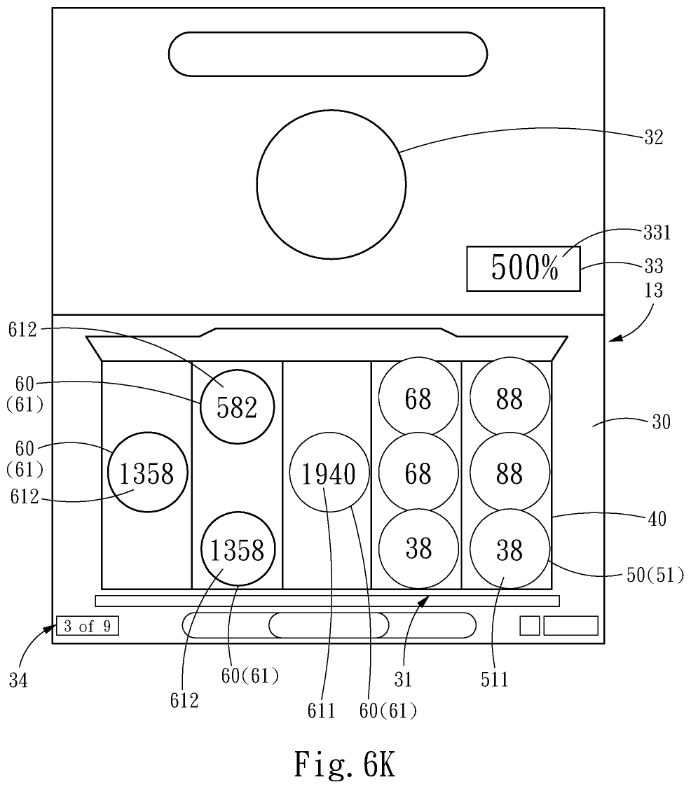

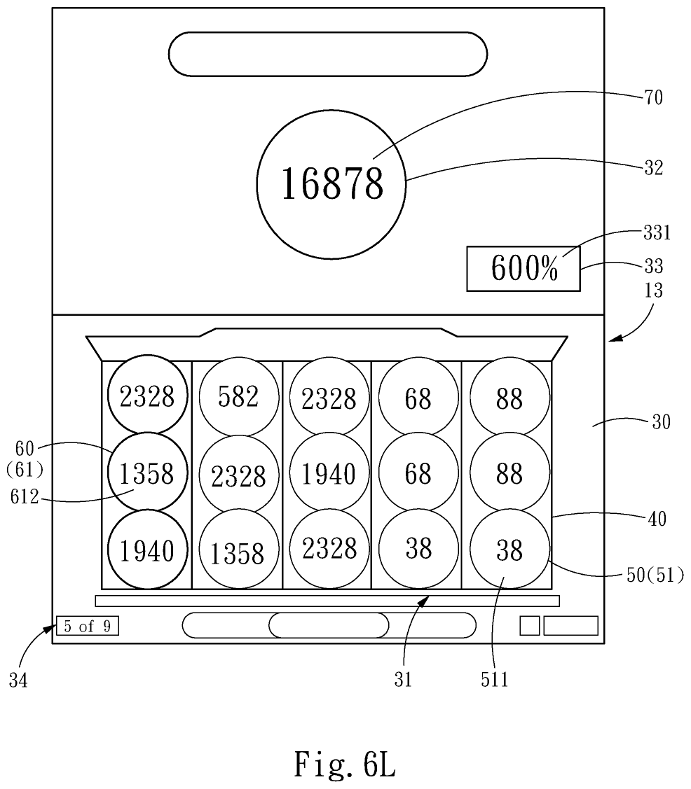

Please refer to FIG. 2, FIG. 3, and FIG. 6A. The invention discloses a game system 10 for getting high reward score by accumulating multiples. The game system 10 is installed in a game machine 20, and the game system 10 provides a slot game. The slot game includes a plurality of game results, and the game system 10 includes a probability to activate a reward game when the slot game is played. The game system 10 includes an input interface 11, a game result generating unit 12, a display unit 13 and a control unit 14. Wherein the display unit 13 includes a game screen 30 for displaying real-time game images of the slot game, and the game screen 30 includes a plurality of display positions 31 arranged side by side. Specifically, in FIG. 6A, in order to express clearly, the display positions 31 are separated by dotted lines, but the dotted lines do not actually exist.

In the slot game, the game result generating unit 12 generates a plurality of first group symbols 50 (as shown in FIG. 6B), the first group symbols 50 are displayed at the display positions 31 of the game screen 30, and the slot game generates the different game results according to type composition of the first group symbols 50. In the reward game, the game result generating unit 12 generates a plurality of second group symbols 60 (as shown in FIG. 6G), and the second group symbols 60 are also displayed at the display positions 31 of the game screen 30.

In one embodiment, the game result generating unit 12 is implemented as a plurality of roller units 40, and the roller units 40 generate the first group symbols 50 (as shown in FIG. 6B) or the second group symbols 60 (as shown in FIG. 6G) by rolling and then stopping. In one embodiment, as shown in a preferred implementation of the roller units 40 in FIG. 6B or FIG. 6G, the first group symbols 50 or the second group symbols 60 displayed at the display positions 31 in a same row are generated by the same roller unit 40, that is, the first group symbols 50 or the second group symbols 60 in a same row are continuously spun to display from top to bottom. For example, if the game screen 30 is the first group symbols 50 or the second group symbols 60 arranged in a 3×5 matrix, it means that the game screen 30 includes the five roller units 40, and each of the roller units 40 simultaneously displays the first group symbols 50 or the second group symbols 60 in 3 columns. When spinning, the first group symbols 50 or the second group symbols 60 will move from a first column to a second column, and finally to a third column, and then disappear from the game screen 30. Alternatively, in another embodiment, a quantity of the roller units 40 corresponds to a quantity of the display positions 31, that is, each of the display positions 31 is provided with one of the roller units 40, and the first group symbols 50 or the second group symbols 60 are respectively generated by the roller units 40 with a corresponding quantity, that is, each of the roller units 40 independently generates one of the first group symbols 50 or one of the second group symbols 60.

The control unit 14 is connected to the display unit 13, the game result generating unit 12 and the input interface 11, and the control unit 14 is used to control operation of the game system 10.

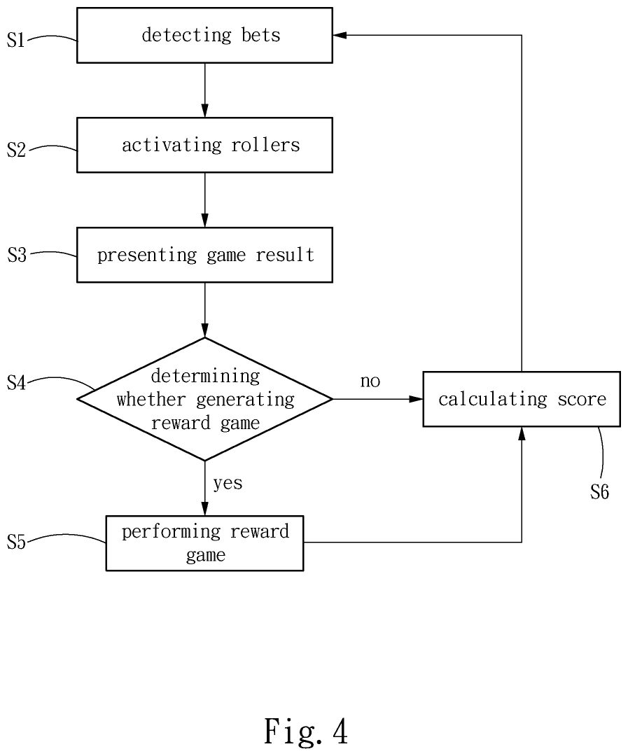

Please refer to FIG. 4 which is a flow chat of game operation of the invention, the slot game is mainly controlled through the control unit 14 to perform step S1: detecting bets; step S2: activating the rollers; step S3: presenting the game results; step S4: determining whether generating the reward game; step S5: performing the reward game; and step S6: calculating a score. Regarding the detailed process of each of the steps of the above-mentioned roller game, one embodiment of the invention is cited and described as follows.

After a player completes preparation before playing the game, such as turning on the gaming system 10, starting the game, etc., the control unit 14 performs step S1: detecting bets. Specifically, the player performs actions such as logging in to an account, placing a bet, etc. through the input interface 11, and the control unit 14 finds out whether the player placing a bet through detection.

Then, as shown in FIG. 6A, the control unit 14 performs step S2: activating the rollers. After the player places a bet, the control unit 14 activates the roller units 40 to spin the roller units 40. As shown in FIG. 6A, long arrows indicates that the roller units 40 are spinning.

Then, as shown in FIG. 6B, the control unit 14 performs step S3: presenting the game results. The roller units 40 generating and displaying the first group symbols 50 as the game results at the display positions 31 of the game screen 30 in a manner of spinning and then stopping. Specifically, as shown in FIG. 6B, patterns of the first group symbols 50 include Pisces, toad, big tree, envelope, gourd, spherical pattern, etc.

Then, the control unit 14 performs step S4: determining whether generating the reward game. In step S4, the control unit 14 determines whether the latest generated game result meeting an activation event. When meeting the activation event, the control unit 14 starts the reward game. The reward game includes a basic score 512 (as shown in FIG. 6B) and an accumulating reward multiple 331 with an initial value (as shown in FIG. 6C), and the reward game has at least one free round being performed sequentially.

In one embodiment, the activation event of the game results is that the first group symbols 50 include a specified quantity of at least one reward pattern 51. For example, the reward pattern 51 can be a spherical pattern as shown in FIG. 6B, and each of the reward patterns 51 includes an individual score 511. All of the individual scores 511 of the at least one reward pattern 51 are calculated accumulatively to be used as the basic score 512, and the basic score 512 is displayed on an information field 32. In addition, each of the display positions 31 where the reward pattern 51 appears will display the individual score 511 corresponding to the reward pattern 51.

When the specified quantity is 6, the game result as shown in FIG. 6B meets the activation event, the reward game is started, and the basic score 512 of the reward game is a value of the individual score 511 of each of the reward patterns 51 accumulatively calculated, that is, the basic score 512 is 68+68+38+88+88+38=388.

Then, the control unit 14 performs step S5: performing the reward game; in step S5, the control unit 14 performing the at least one free round sequentially. As shown in FIG. 6C, it is the game screen 30 of the reward game, each of the display positions 31 where the reward patterns 51 appear will keep displaying the reward patterns 51 until the reward game ends. In the reward game, the initial value of the accumulating reward multiple 331 and a quantity of the at least one free round are determined according to the player's bet or/and a quantity of the reward patterns 51. In this embodiment, the initial value of the accumulating reward multiple 331 is 100%, and the quantity of the at least one free round is 6. In different embodiments, the display unit 13 includes a multiple display field 33 that displays the accumulating reward multiple 331, the display unit 13 also includes a round display field 34, and the round display field 34 displays a total quantity and a played quantity of the at least one free round, which can be represented by B of A, wherein B is the played quantity and A is the total quantity.

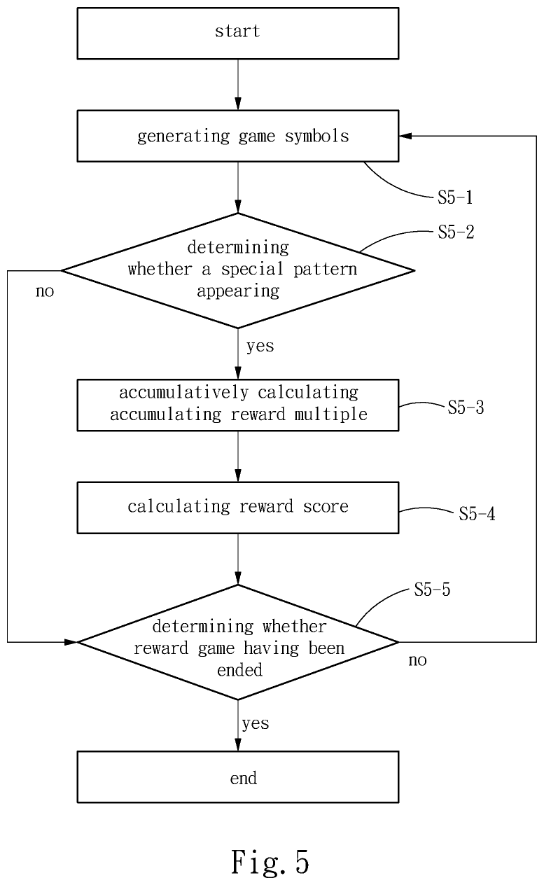

Please refer to FIG. 5 which is a flow chart of game operation of the reward game of the invention, in performing each of the free rounds of the reward game sequentially, the control unit 14 performs the following steps: step S5-1: generating game symbols; step S5-2: determining whether a special pattern appearing; step S5-3: accumulatively calculating the accumulating reward multiple; step S5-4: calculating a reward score; and step S5-5: determining whether the reward game having been ended. The detailed process of each of the steps of the above-mentioned reward game is described as follows.

After the reward game starts, the control unit 14 performs step S5-1: generating the game symbols. As shown in FIG. 6D, step S5-1 is to generate the second group symbols 60 through the game result generating unit 12, and the second group symbols 60 are displayed at the display positions 31 of the game screen 30.

Then the control unit 14 performs step S5-2: determining whether a special pattern appearing; in step S5-2. When the control unit 14 determines that any one of the second group symbols 60 generated by the game result generating unit 12 is a special pattern 61, the control unit 14 keeps display the special pattern 61 at the display position 31 where the special pattern 61 appearing in the reward game. As shown in FIG. 6D, the special pattern 61 can be a spherical pattern. In addition, the second group symbols 60 can further include an independent percentage symbol 62, an independent session symbol 63, etc. (as shown in FIG. 6G). Moreover, if the second group symbols 60 do not belong to the special pattern 61, the independent percentage symbol 62 or the independent session symbol 63, for the sake of conciseness of the screen, the second group symbols 60 are displayed as blank graphics.

Then the control unit 14 performs step S5-3: accumulatively calculating the accumulating reward multiple. In step S5-3, the special pattern 61 includes a percentage value symbol 611 (as shown in FIG. 6D), and the control unit 14 accumulatively calculates a current value of the percentage value symbol 611 and a value of the accumulating reward multiple 331 to generate a latest value of the accumulating reward multiple 331. That is, when the value of the percentage value symbol 611 is 50% and the current value of the accumulating reward multiple 331 is 100%, 50% is accumulatively calculated to generate the latest value of the accumulating reward multiple 331 of 150%, as shown in FIG. 6E, and 150% is displayed on the multiple display field 33.

Then the control unit 14 performs step S5-4: calculating a reward score. In step S5-4, the control unit 14 uses a product of the basic score 512 and the accumulating reward multiple 331 latest generated as a reward score 612 of the special pattern 61. As shown in FIG. 6E, a value of the basic score 512 is 388 (see FIG. 6B), and the value of the accumulating reward multiple 331 is 150%. Therefore, the reward score 612 of the special pattern 61 is 388*150%=582. And on the display of the game screen 30, the reward score 612 covers the percentage value symbol 611, so that the player can clearly know the reward score 612 of the special pattern 61.

In addition, in order to attract the player's attention and let the player know clearly a number of the reward score 612 that can be obtained; when any one of the second group symbols 60 generated by the game result generating unit 12 is the special pattern 61, the game screen 30 will present an animation image, and the animation image includes a process of the control unit 14 accumulatively calculating each of the individual score 511 of the reward patterns 51 sequentially and displaying on the special pattern 61. Further, the animation image further includes a process of calculating a product of the basic score 512 and the accumulating reward multiple 331 latest generated to generate the reward score 612 and displaying on the special pattern 61. To be more clear, each of the individual score 511 of the reward patterns 51 is sequentially and accumulatively calculated and filled on the special pattern 61, and finally the basic score 512 is displayed on the special pattern 61 (not shown in the figure). Then the latest value of the accumulating reward multiple 331 is filled on the special pattern 61, and the value of the accumulating reward multiple 331 is multiplied by the basic score 512 to generate the reward score 612 (as shown in FIG. 6E).

Then the control unit 14 performs step S5-5: determining whether the reward game having been ended. In step S5-5, the control unit 14 determines whether all of the at least one free round of the reward game having been played, if so, ends the reward game, and if otherwise, continues to perform the at least one free round sequentially. In step S5-5, the determining is made based on a total quantity and a played quantity of the at least one free round displayed on the round display field 34. When the player quantity is equal to the total quantity, it is determined that the reward game has ended. As shown in FIG. 6E, the player quantity is 1, and the total quantity is 6, so the at least one free round will be performed continuously and sequentially.

Please continue to refer to FIG. 6F for a new round of the at least one free round. The display position 31 where the special pattern 61 appeared in the previous round keeps display the appeared special pattern 61. In this free round, the new special pattern 61 includes the percentage value symbol 611 (200%) (not shown in the figure) (the percentage value symbol 611 has been covered by the reward score 612), the value 150% of the accumulating reward multiple 331 displayed on the multiple display field 33 is accumulatively calculated by adding 200% to become 350%, and the reward score 612 of the special pattern 61 is 388*350%=1358.

As shown in FIG. 6G, which is another new round of the at least one free round. Similarly, the display position 31 where the special pattern 61 has appeared keeps displaying the special pattern 61. In this free round, the two special patterns 61, the independent percentage symbol 62 (100%), and the independent session symbol 63 (+1 SPIN) appear. Further, one of the special patterns 61 includes a session quantity symbol 613 (+2 SPIN), and the other special pattern 61 includes the percentage value symbol 611 (50%). When the special patterns 61, the independent percentage symbol 62, and the independent session symbol 63 appear in the second group symbols 60, the above-mentioned symbols can be processed by the control unit 14 from top to bottom and from left to right sequentially.

Thus, the control unit 14 first processes the special pattern 61 with the session quantity symbol 613 (+2 SPIN). When the special pattern 61 includes the session quantity symbol 613 (as shown in FIG. 6G), the control unit 14 correspondingly increases a quantity of the free rounds according to a quantity of the session quantity symbol 613. That is, on the round display field 34, the total quantity is increased to 8, and the control unit 14 calculates the reward score 612 of the special pattern 61 with the session quantity symbol 613 (+2 SPIN) as 388*350%=1358, and the reward score 612 covers the session quantity symbol 613, as shown in FIG. 6H.

Then the control unit 14 processes the independent percentage symbol 62 (100%). In the reward game, when the independent percentage symbol 62 appears in any one of the display positions 31 (as shown in FIG. 6G), the control unit 14 accumulatively calculates a display value 621 of the independent percentage symbol 62 to increase a value of the accumulating reward multiple 331, and the independent percentage symbol 62 (100%) disappears from the game screen 30 after being accumulatively calculated, as shown in FIG. 6I. Therefore, the value of the accumulating reward multiple 331 displayed on the multiple display field 33 is accumulatively calculated by adding 350% with 100% to become 450%.

Then the control unit 14 processes the independent session symbol 63 (+1 SPIN). In the reward game, when the independent session symbol 63 appears in any one of the display positions 31 (as shown in FIG. 6I), the control unit 14 correspondingly increases a quantity of the free rounds according to a display quantity 631 of the independent session symbol 63. Therefore, the control unit 14 correspondingly increases a quantity of the free round according to the display quantity 631, that is, the total quantity is increased to 9 on the round display field 34, and the control unit 14 makes the independent session symbol 63 (+1 SPIN) accumulatively calculated disappear from the game screen 30, as shown in FIG. 6J.

Then the control unit 14 processes the special pattern 61 with the percentage value symbol 611 (50%) (as shown in FIG. 6J), a value of the accumulating reward multiple 331 displayed on the multiple display field 33 is accumulatively calculated by adding 450% with 50% to become 500%, and the reward score 612 of the special pattern 61 is 388*500%=1940, as shown in FIG. 6K.

With the process described above, when the invention is in an optimal scenario, the special pattern 61 or the reward pattern 51 is displayed at each of the display positions 31, as shown in FIG. 6L. When there is no display position 31 that can display the second group symbols 60, the control unit 14 determines that the reward game has ended even if the quantity of times being played is not equal to the total quantity.

After determining that the reward game has ended, the control unit 14 then performs step S6: calculating a score (as shown in FIG. 4) S6; after the reward game having been ended, the control unit 14 calculates a game score 70 of the slot game according to the reward scores 612 of each of the special patterns 61 and the individual scores 511 of each of the reward patterns 51, and displaying the game score 70 on the information field 32, as shown in FIG. 6L.

As mentioned above, this round of the game is completed. At this time, the control unit 14 performs step S1 again, and the player can choose to bet again to enable the control unit 14 performs step S2 again, that is, starting spinning of the roller units 40 again to start another round of the slot game.

In summary, advantages of the invention at least include:
1. In the process of performing the at least one free round sequentially, when the obtained special pattern includes the percentage value symbol, the control unit can accumulatively calculate the value of the percentage value symbol to increase the value of the accumulating reward multiple. Therefore, as long as the value of the accumulating reward multiple continues to accumulate, the reward score of the special pattern will increase steadily to increase the score fluctuation of the reward game, so that the player can maintain the hope of obtaining high reward scores, thereby maintaining the player's interest for a long period of time, and increasing the time of use of the slot machine.
2. Under the same operation mode, the system operator does not need to invest too much design cost, and through the same operation mode, the player has the opportunity to obtain high reward scores, will not have expected results and feel bored, and can still maintain anticipation and surprise to avoid the reward game from becoming a breakpoint for the player to stop playing.
3. The method for increasing the values is achieved by calculating repetitively and accumulatively, which can quickly increase the values and has the probability to increase the quantity of the at least one free round. Therefore, the player will not feel bored because the expected result is not good, and expectation and surprise can be maintained before the game ends to enhance amusement.

What is claimed is:

1. A game system for getting high reward score by accumulating multiples, providing a slot game, the slot game having a plurality of game results, the game system comprising:
a display unit, the display unit comprising a game screen, the game screen displaying real-time game images of the slot game, and the game screen comprising a plurality of display positions arranged side by side;
a game result generating unit, the game result generating unit generating a plurality of first group symbols, the plurality of first group symbols being displayed at the plurality of display positions of the game screen, the slot game generating one of the plurality of game results according to type and composition of the first group symbols; and
a control unit, the control unit being connected to the display unit and the game result generating unit, and the control unit performing following steps of:
determining whether the game result latest generated meets an activation event, when meeting the activation event, starting a reward game, the reward game comprising a basic score and an accumulating reward multiple with an initial value, the reward game comprising at least one free round performed sequentially; and
performing the at least one free round sequentially, and in each round of the at least one free round of the reward game performed sequentially, the control unit performing following steps of:
generating a plurality of second group symbols through the game result generating unit, displaying the plurality of second group symbols at the plurality of display positions of the game screen;
when determining that any one of the plurality of second group symbols generated by the game result generating unit being a special pattern, keeping display of the special pattern at the display position where the special pattern appearing in the reward game;
if the special pattern comprising a percentage value symbol, accumulatively calculating a value of the percentage value symbol and a current value of the accumulating reward multiple to generate a latest value of the accumulating reward multiple;
calculating a product of the basic score and the accumulating reward multiple latest generated to be used as a reward score of the special pattern; and
determining whether the at least one free round of the reward game having been played, if so, ending the reward game, if otherwise, continuing the at least one free round sequentially.

2. The game system as claimed in claim 1, wherein the game result generating unit is a plurality of roller units, and the roller units generate the plurality of first group symbols or the plurality of second group symbols by rolling and then stopping.

3. The game system as claimed in claim 2, wherein a quantity of the roller units corresponds to a quantity of the display positions.

4. The game system as claimed in claim 2, wherein the plurality of first group symbols or the plurality of second group symbols displayed at the plurality of display positions in a same row are generated by the same roller unit.

5. The game system as claimed in claim 1, wherein the activation event of the game result is that the plurality of first group symbols comprise a specified quantity of at least one reward pattern, each of the at least one reward patterns comprises an individual score, the individual scores of the at least one reward pattern are calculated accumulatively to be used as the basic score, and each of the display positions where the reward patterns appear keeps displaying the reward patterns until the reward game ends.

6. The game system as claimed in claim 5, wherein each of the display positions where the reward patterns appear displays the individual score of each of the reward patterns.

7. The game system as claimed in claim 5, wherein when any one of the second group symbols generated by the game result generating unit is the special pattern, the game screen presents an animation image, and the animation image includes a process of the control unit accumulatively calculating the individual score of each of the reward patterns sequentially and displaying on the special pattern.

8. The game system as claimed in claim 7, wherein the animation image further includes a process of calculating the product of the basic score and the latest accumulating reward multiple to generate the reward score and displaying on the special pattern.

9. The game system as claimed in claim 7, wherein each of the display positions where the reward pattern appears displays the individual score of the reward pattern.

10. The game system as claimed in claim 1, wherein when the special pattern comprises a session quantity symbol, the control unit correspondingly increases a quantity of the free rounds according to a quantity of the session quantity symbol.

11. The game system as claimed in claim 1, wherein the second group symbols comprise an independent percentage symbol, in the reward game, when the independent percentage symbol appears at any one of the display positions, the control unit accumulatively calculates a display value of the independent percentage symbol and a value of the accumulating reward multiple to increase the value of the accumulating reward multiple.

12. The game system as claimed in claim 1, wherein the second group symbols include an independent session symbol, in the reward game, when the independent session symbol appears at any one of the display positions, the control unit correspondingly increases a quantity of the free rounds according to a display quantity of the independent session symbol.

13. The game system as claimed in claim 1, wherein the display unit comprises a multiple display field that displays the accumulating reward multiple.

14. The game system as claimed in claim 1, wherein the display unit has a round display field, and the round display field displays a total quantity and a played quantity of the at least one free round.
